(19) United States
(12) Patent Application Publication
(10) Pub. No.: US 2017/0100923 A1
(43) Pub. Date: Apr. 13, 2017

(54) METHOD OF PRODUCING A SURFACE PROTECTION COMPOSITE

(71) Applicant: Covestro LLC, Pittsburgh, PA (US)

(72) Inventors: Zhizhong Liu, Wilbraham, MA (US); Heath Rawlings, South Deerfield, MA (US)

(73) Assignee: Covestro LLC, Pittsburg, PA (US)

(21) Appl. No.: 15/128,239

(22) PCT Filed: Mar. 26, 2015
(86) PCT No.: PCT/US15/22677

§ 371 Date: Sep. 22, 2016

Related U.S. Application Data
(60) Provisional application No. 61/970,522, filed on Mar. 26, 2014.

(51) Int. Cl. B32B 37/15; B32B 7/06; B32B 38/10; C09J 175/04; B32B 27/06; B32B 37/12; C09J 7/02; C09J 133/08; B29C 47/00; B32B 27/40

(52) U.S. Cl. CPC B32B 37/153; B29C 47/0004; B29C 47/0021; B32B 7/06; B29C 47/0064; B32B 38/10; B32B 27/40; B32B 27/06; B32B 37/12; C09J 7/0296; C09J 7/0246; C09J 133/08; C09J 175/04; B29K 2075/00

(57) ABSTRACT

The present invention provides a method of making a three-layer aliphatic thermoplastic polyurethane (TPU) surface protection composite. The method involves extruding an aliphatic thermoplastic polyurethane (TPU) layer onto a substrate layer at the flat die extrusion nip comprising a rubber roller in the back position and a polished steel roller in the front position; cooling the extruded aliphatic thermoplastic polyurethane; feeding the two-layer thermoplastic polyurethane (TPU) composite film into a downstream nip comprising at least one rubber roller; and laminating a flexible polymer interleaf film onto the exposed thermoplastic polyurethane (TPU) side of the two-layer composite under pressure in that nip. The surface protection composite of the present invention may be included in a variety of products for use in automotive, electronics or furniture applications

### CROSS-REFERENCE TO RELATED APPLICATIONS

This application is a national stage application (under 35 U.S.C. §371) of PCT/US2015/022677, filed Mar. 26, 2015, which claims the benefit of U.S. Provisional Application No. 61/970,522, filed Mar. 26, 2014, both of which are incorporated herein by reference in their entirety.

### FIELD OF THE INVENTION

The present invention relates in general to surface protection, and more specifically to a clear, aliphatic thermoplastic polyurethane (TPU) film with optical level surface finishes which is coated with a thin layer of pressure sensitive adhesive based on acrylate, polyurethane or other chemistries.

### BACKGROUND OF THE INVENTION

Clear, aliphatic thermoplastic polyurethane (TPU) film with optical level of surface finishes coated with a thin layer of pressure sensitive adhesive based on acrylate, polyurethane or other chemistries are seeing rapid expansion in surface protection applications in automotive, boats, consumer electronics and furniture industries.

The dominant thermoplastic polyurethane (TPU) surface protection film products on the market are based on extrusion of aliphatic TPU resin onto the glossy side of a brushed polyethylene terephthalate (PET) carrier film. This two-layer film is wound into rolls, and the thermoplastic polyurethane (TPU) film allowed to fully develop its microstructures and achieve equilibrium physical and chemical properties before subjecting the film to subsequent coating procedures to put on an adhesive layer or even adding a scratch resistant top coating onto the aliphatic thermoplastic polyurethane (TPU) film.

Although the brushed polyethylene terephthalate (PET) carrier film helps wind the soft and sticky aliphatic thermoplastic polyurethane (TPU) film into usable rolls, it contributes some surface quality issues to the aliphatic TPU surface protection film. As all surface protection applications require clean, defect-free, glossy, and optical level surface finishes for the thermoplastic polyurethane (TPU) film, among the major shortcomings of the current two-layer (aliphatic thermoplastic polyurethane (TPU)/brushed polyethylene terephthalate (PET)) film include transferring of brush marks from the polyethylene terephthalate (PET) layer into the TPU surface during winding up a roll, contamination of thermoplastic polyurethane (TPU) surface by residual polyethylene terephthalate (PET) debris trapped in brushed grooves, and possible web wrinkling issues aggravated by sticking of the tacky thermoplastic polyurethane (TPU) onto the brushed polyethylene terephthalate (PET) surface whenever significant gauge or stress unevenness occurs during winding up a roll.

All the above described surface deficiencies associated with the use of brushed polyethylene terephthalate (PET) film can result in unacceptable products or significantly reduced yield rate. On the other hand, a polyethylene terephthalate (PET) or other carrier film with gloss/gloss surface finish is not the right solution for two-layer aliphatic thermoplastic polyurethane (TPU) surface protection film either. Severe watermark defects will develop on the exposed thermoplastic polyurethane (TPU) surface due to lack of channels to bleed air entrapped between the sticky thermoplastic polyurethane (TPU) surface and glossy polyethylene terephthalate (PET) during roll winding up, which leads to patches of watermark impressions on the thermoplastic polyurethane (TPU) surface as the material gradually solidifies and builds up its equilibrium micro-structures during storage.

### SUMMARY OF THE INVENTION

Accordingly, the present invention provides methods of making three-layer aliphatic thermoplastic polyurethane (TPU) surface protection composite film. The surface protection composites of the present invention may be included in a variety of products for use in automotive, electronics or furniture applications. The main benefits of these new methods to make aliphatic thermoplastic polyurethane (TPU) surface protection film are the ease of winding up product rolls free of any wrinkles and watermark defects compared to a two-layer aliphatic thermoplastic polyurethane (TPU) surface protection film. The three-layer composite structure also protect the surfaces of the aliphatic thermoplastic polyurethane (TPU) film from damaging and contamination during transportation and storage and preserve the optic quality of the aliphatic thermoplastic polyurethane (TPU) film before downstream coating processes are applied.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIG. 1 illustrates one embodiment of the methods of the present invention; and

FIG. 2 illustrates a second embodiment of the methods of the present invention.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

Any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicants reserve the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. §112(a), and 35 U.S.C. §132(a).

Applicants reserve the right to proviso out or exclude any individual members of any such group, including any sub-ranges or combinations of sub-ranges within the group, that can be claimed according to a range or in any similar manner, if for any reason Applicants choose to claim less than the full measure of the disclosure, for example, to account for a reference that Applicants may be unaware of at the time of the filing of the application. Further, Applicants reserve the right to proviso out or exclude any individual resin-containing dispersion coating, or any members of a claimed group, if for any reason Applicants choose to claim less than the full measure of the disclosure, for example, to account for a reference that Applicants may be unaware of at the time of the filing of the application.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicants reserve the right to amend this specification to expressly recite any subject matter, or portion thereof, incorporated by reference herein.

Reference throughout this specification to “various non-limiting embodiments”, “certain embodiments”, or the like, means that a particular feature or characteristic may be included in an embodiment. Thus, use of the phrase “in various non-limiting embodiments”, “in certain embodiments,” or the like, in this specification does not necessarily refer to a common embodiment, and may refer to different embodiments. Further, the particular features or characteristics may be combined in any suitable manner in one or more embodiments. Thus, the particular features or characteristics illustrated or described in connection with various or certain embodiments may be combined, in whole or in part, with the features or characteristics of one or more other embodiments without limitation. Such modifications and variations are intended to be included within the scope of the present specification.

Although compositions and methods are described in terms of “comprising” various components or steps, the compositions and methods can also “consist essentially of” or “consist of” the various components or steps.

The present disclosure is generally directed to new methods of producing a three-layer extruded aliphatic thermoplastic polyurethane (TPU) surface protection film which can effectively overcome the major quality or process shortcomings associated with current two-layer thermoplastic polyurethane (TPU)/polyethylene terephthalate (PET) surface protection films commercially available.

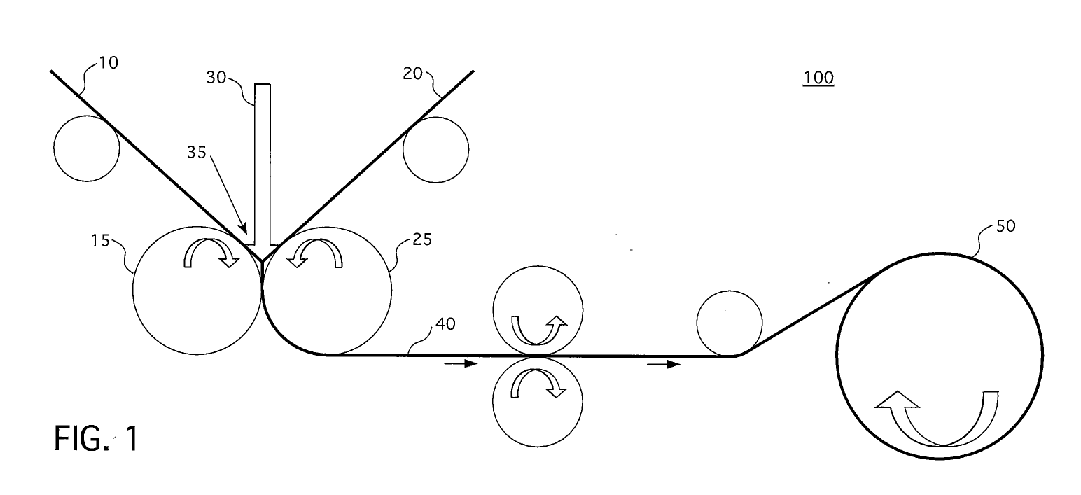

One non-limiting embodiment of the inventive method 100, as shown in FIG. 1, involves extruding aliphatic thermoplastic polyurethane (TPU) melt 30 through a flat die extrusion device and sandwiching the thermoplastic polyurethane (TPU) melt between two films: a first (substrate) film 10 and a second (interleaf) film 20, at the extrusion nip 35 formed by a rubber roller 25 and a steel roller 15 in a flat die extrusion rig. Each of the first and second films independently has a smooth or polished surface to laminate with the aliphatic thermoplastic polyurethane (TPU) melt 30 during the extrusion lamination process. The resultant three-layer thermoplastic polyurethane (TPU) composite film 40 is subsequently cooled and wound up onto product roll 50.

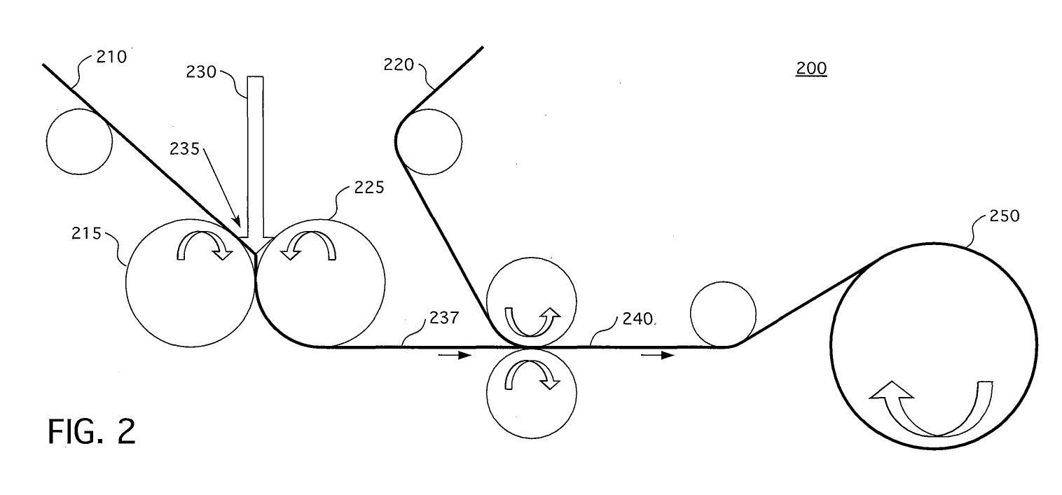

In a second non-limiting embodiment of the method of the present invention 200, as shown in FIG. 2, an aliphatic thermoplastic polyurethane (TPU) layer 230 is extruded through a flat die extrusion device onto a smooth or polished surface of a first (substrate) film 210 in the nip 235 formed by a pair of rollers. The rollers comprise a rubber roller 225 in the back position and a polished chrome coated steel roller 215 in the front position relative to the moving direction of the web in the flat die extrusion rig. The two-layer thermoplastic polyurethane (TPU) composite film 237 is cooled and fed into a second pair of nip rollers 239 downstream of the first pair of rollers 215 and 225. The second pair of nip rollers comprise at least one rubber roller. A second (interleaf) film 220 is fed into this nip and laminates the smooth or polished surface of the interleaf film 220 with the exposed thermoplastic polyurethane (TPU) surface under pressure. The three-layer thermoplastic polyurethane (TPU) composite 240 is wound onto a product roll 250.

In certain embodiments of the invention, aliphatic thermoplastic polyurethanes are used, such as those prepared according to U.S. Pat. No. 6,518,389, the entire contents of which is incorporated herein by reference.

Thermoplastic polyurethane elastomers are well known to those skilled in the art. They are of commercial importance due to their combination of high-grade mechanical properties with the known advantages of cost-effective thermoplastic processability. A wide range of variation in their mechanical properties can be achieved by the use of different chemical synthesis components. A review of thermoplastic polyurethanes, their properties and applications is given in Kunststoffe [Plastics] 68 (1978), pages 819 to 825, and in Kautschuk, Gummi, Kunststoffe [Natural and Vulcanized Rubber and Plastics] 35 (1982), pages 568 to 584.

Thermoplastic polyurethanes are synthesized from linear polyols, mainly polyester diols or polyether diols, organic diisocyanates and short chain diols (chain extenders). Catalysts may be added to the reaction to speed up the reaction of the components.

The relative amounts of the components may be varied over a wide range of molar ratios in order to adjust the properties. Molar ratios of polyols to chain extenders from 1:1 to 1:12 have been reported. These result in products with hardness values ranging from 80 Shore A to 85 Shore D according to ASTM D2240.

Thermoplastic polyurethanes can be produced either in stages (prepolymer method) or by the simultaneous reaction of all the components in one step (one shot). In the former, a prepolymer formed from the polyol and diisocyanate is first formed and then reacted with the chain extender. Thermoplastic polyurethanes may be produced continuously or batch-wise. The best-known industrial production processes are the so-called belt process and the extruder process.

Examples of suitable polyols include difunctional polyether polyols, polyester polyols, and polycarbonate polyols. Small amounts of trifunctional polyols may be used, yet care must be taken to make certain that the thermoplasticity of the thermoplastic polyurethane remains substantially un-effected.

Suitable polyester polyols include those which are prepared by polymerizing ε-caprolactone using an initiator such as ethylene glycol, ethanolamine and the like. Further suitable examples are prepared by esterification of polycarboxylic acids. The polycarboxylic acids may be aliphatic, cycloaliphatic, aromatic and/or heterocyclic and they may be substituted, e.g., by halogen atoms, and/or unsaturated. The following are mentioned as examples: succinic acid; adipic acid; suberic acid; azelaic acid; sebacic acid; phthalic acid; isophthalic acid; trimellitic acid; phthalic acid anhydride; tetrahydrophthalic acid anhydride; hexahydrophthalic acid anhydride; tetrachlorophthalic acid anhydride, endomethylene tetrahydrophthalic acid anhydride; glutaric acid anhydride; maleic acid; maleic acid anhydride; fumaric acid; dimeric and trimeric fatty acids such as oleic acid, which may be mixed with monomeric fatty acids; dimethyl terephthalates and bis-glycol terephthalate. Suitable polyhydric alcohols include, e.g., ethylene glycol; propylene glycol-(1,2) and -(1,3); butylene glycol-(1,4) and -(1,3); hexanediol-(1,6); octanediol-(1,8); neopentyl glycol; (1,4-bis-hydroxy-methylcyclohexane); 2-methyl-1,3-propanediol; 2,2,4-tri-methyl-1,3-pentanediol; triethylene glycol; tetraethylene glycol; polyethylene glycol; dipropylene glycol; polypropylene glycol; dibutylene glycol and polybutylene glycol, glycerine and trimethlyolpropane.

Suitable polyisocyanates for producing the thermoplastic polyurethanes useful in the present invention may be, for example, organic aliphatic diisocyanates including, for example, 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3- and -1,4-diisocyanate, 1-isocyanato-2-isocyanatomethyl cyclopentane, 1-isocyanato-3-isocyanatomethyl-3,5,5-trimethyl-cyclohexane (isophorone diisocyanate or IPDI), bis-(4-isocyanatocyclohexyl)-methane, 2,4′-dicyclohexylmethane diisocyanate, 1,3- and 1,4-bis-(isocyanatomethyl)-cyclohexane, bis-(4-isocyanato-3-methylcyclohexyl)-methane, α,α,α′,α′-tetramethyl-1,3- and/or -1,4-xylylene diisocyanate, 1-isocyanato-1-methyl-4(3)-isocyanatomethyl cyclohexane, 2,4- and/or 2,6-hexahydrotoluylene diisocyanate, and mixtures thereof.

In various non-limiting embodiments, chain extenders with molecular weights of 62 to 500 include aliphatic diols containing 2 to 14 carbon atoms, such as ethanediol, 1,6-hexanediol, diethylene glycol, dipropylene glycol, and 1,4-butanediol in particular, for example. However, diesters of terephthalic acid with glycols containing 2 to 4 carbon atoms are also suitable, such as terephthalic acid-bis-ethylene glycol or -1,4-butanediol for example, or hydroxyalkyl ethers of hydroquinone, such as 1,4-di-(β-hydroxyethyl)-hydroquinone for example, or (cyclo)aliphatic diamines, such as isophorone diamine, 1,2- and 1,3-propylenediamine, N-methyl-propylenediamine-1,3 or N,N′-dimethyl-ethylenediamine, for example, and aromatic diamines, such as toluene 2,4- and 2,6-diamines, 3,5-diethyltoluene 2,4- and/or 2,6-diamine, and primary ortho-, di-, tri- and/or tetraalkyl-substituted 4,4′-diaminodiphenylmethanes, for example. Mixtures of the aforementioned chain extenders may also be used. Optionally, triol chain extenders having a molecular weight of 62 to 500 may also be used. Moreover, customary monofunctional compounds may also be used in small amounts, e.g., as chain terminators or demolding agents. Alcohols such as octanol and stearyl alcohol or amines such as butylamine and stearylamine may be cited as examples.

To prepare the thermoplastic polyurethanes, the synthesis components may be reacted, optionally in the presence of catalysts, auxiliary agents and/or additives, in amounts such that the equivalent ratio of NCO groups to the sum of the groups which react with NCO, particularly the OH groups of the low molecular weight diols/triols and polyols, is 0.9:1.0 to 1.2:1.0, in certain embodiments from 0.95:1.0 to 1.10:1.0.

Suitable catalysts include tertiary amines which are known in the art, such as triethylamine, dimethyl-cyclohexylamine, N-methylmorpholine, N,N′-dimethyl-piperazine, 2-(dimethyl-aminoethoxy)-ethanol, diazabicyclo-(2,2,2)-octane and the like, for example, as well as organic metal compounds in particular, such as titanic acid esters, iron compounds, tin compounds, e.g., tin diacetate, tin dioctoate, tin dilaurate or the dialkyltin salts of aliphatic carboxylic acids such as dibutyltin diacetate, dibutyltin dilaurate or the like. In some embodiments, the catalysts are organic metal compounds, particularly titanic acid esters and iron and/or tin compounds.

In addition to difunctional chain extenders, small quantities of up to about 5 mol. %, based on moles of the bifunctional chain extender used, of trifunctional or more than trifunctional chain extenders may also be used.

Trifunctional or more than trifunctional chain extenders of the type in question are, for example, glycerol, trimethylolpropane, hexanetriol, pentaerythritol and triethanolamine.

Suitable thermoplastic polyurethanes are available in commerce, for instance, from Bayer MaterialScience under the TEXIN trademark, from BASF under the ELASTOLLAN trademark and from Lubrizol under the trade names of ESTANE and PELLETHANE.

Various methods of making three-layer aliphatic TPU surface protection are illustrated in FIGS. 1 and 2. An aliphatic thermoplastic polyurethane (TPU) film, 2 mil to 15 mil, is extruded onto the smooth or polished side of a substrate film (Carrier 1 as shown in both FIGS. 1 and 2), of gauge 1 to 10 mil through a pair of nip rollers comprising a rubber roller with 90 A or less hardness according to ASTM D2240 in the rear position and a polished chrome coated or TEFLON coated steel roll in the front position relative to the web moving direction in the flat die extrusion rig.

In various non-limiting embodiments, the substrate film has a melt or softening temperature of 100° C. or greater and Young's modulus according to ASTM D882 of 50 MPa or greater. In certain embodiments, the carrier has one glossy or polished surface, the surface roughness (Ra) according to ISO 4287/88 of less than 1.0 μm and gloss (according to ISO 2813, Angle 60°) of 85% or greater. The other side of the substrate film may be of any surface finish: matte, glossy, smooth, embossed or polished, although the surface roughness (Ra) according to ISO 4287/88 of this surface is less than 10 μm in certain embodiments, and less than 5 μm in certain other embodiments. The substrate film is an essentially planar, self-supporting, stretchable, flexible, thermoplastic polymeric film which in various embodiments may be transparent, translucent or opaque. It has a substantially uniform thickness, in the range from about 0.025 to 0.50 mm (1 to 20 mils). Suitable substrate films may be made of polyethylene terephthalate (PET), polycarbonate (PC), polypropylene (PP), polyethylene (PE), polybutylene terephthalate (PBT), polyethylene naphthalate, glycol-polyethylene terephthalate, amorphous polyethylene terephthalate, polyvinyl chloride, cellulose triacetate, polyamide, styrene-methyl methacrylate copolymer, or cyclic olefin copolymer, or a combination thereof.

In various non-limiting embodiments, the first (substrate) film may a 1.0 mil to 3.5 mil polyethylene terephthalate (PET) film or a 1.5 mil to 4.0 mil bi-axially oriented polypropylene (BOPP) film having a glossy or polished surface finish on both sides. PET film may be used in certain embodiments because of its excellent mechanical and chemical properties and its heat stability. Methods of PET film production are well known. (See e.g., U.S. Pat. Nos. 4,115,371, 4,205,157, 4,970,249 and 5,017,680, the entire contents of each of which are incorporated by reference.)

Suitable polyethylene terephthalates for producing films useful in the practice of the present invention have intrinsic viscosities of from 0.4 to 1.3 dl/g and in certain embodiments of from 0.5 to 0.9 dl/g, as measured in phenol/o-dichlorobenzene (1:1 parts by weight) in a concentration of 5 g/at 25° C.

Such polyethylene terephthalates may be prepared by esterifying dicarboxylic acids, in some embodiments, pure terephthalic acid, and/or transesterifying the corresponding dimethyl esters with from 1.05 to 5 mols in certain embodiments of the invention, and of from 1.8 to 3.6 mols of the diols in certain other embodiments, relative to 1 mol of the dicarboxylic acid component, in the presence of esterification catalysts and/or reaction catalysts respectively at between 150° and 250° C. (reaction step A) and subjecting the reaction products thus obtained to polycondensation in the presence of esterification catalysts at between 200 and 300° C. under reduced pressure, <1 mm Hg (reaction step B).

Catalysts play a central role in the preparation of polyesters. They not only have a considerable influence on the reaction rate of the transesterification reactions but also influence side reactions and the heat stability and the color of the polyethylene terephthalates. Virtually all the metals, in the form of very diverse compounds thereof, have been used as transesterfication catalysts and polycondensation catalysts (R. E. Wilfang in Polym. Sci. 54, 385 (1961)).

Among the many known polycondensation catalysts for reaction step B, compounds of germanium, antimony and titanium may be used, separately or in combination. For example, U.S. Pat. No. 2,578,660 describes the use of germanium and germanium dioxide. Germanium compounds do indeed give polyesters with an excellent degree of whiteness but have only an average catalytic activity.

The use of antimony compounds (in combination with phosphorus compounds as stabilizers) is known, for example from U.S. Pat. No. 3,441,540 and from East German Patent Specification Nos. 30,903 and 45,278.

Titanium compounds, inter alia titanium tetraisopropylate or titanium tetrabutylate, are described, as catalysts for the preparation of fiber-forming polyesters, in, for example, British Patent Specification Nos. 775,316, 777,216, 793,222 and 852,061, U.S. Pat. Nos. 2,727,881, 2,822,348 and 3,075,952 and (in combination with phosphorus-containing stabilizers) in East German Patent Specification No. 45,278.

Soluble antimony compounds which possess a good catalytic activity for the polycondensation reaction have the disadvantage that, under the reaction conditions, they are relatively easily reduced to metallic antimony and as a result give rise to a greyish-tinged discoloration of the polycondensate to a greater or lesser extent. According to investigations carried out by H. Zimmerman (Faserforschung and Textiltechnik 13, No. 11 (1962), 481-90), soluble titanium compounds are clearly superior to comparable antimony compounds in respect of their catalytic activity.

After the end of reaction step A, stabilizers may be added to the reaction mixture to inhibit the catalysts necessary for reaction step A and to increase the stability of the end product. Such inhibitors are described by H. Ludewig, Polyesterfasern (Polyester fibers), 2nd edition, Akademie-Verlag, Berlin 1974, in U.S. Pat. No. 3,028,366 and in German Offenlegungsschriften (German Published Specifications) 1,644,977 and 1,544,986. Examples of such inhibiting compounds include phosphoric acid and phosphorous acid and their esters, such as trinonylphenyl phosphate or triphenyl phosphate or triphenyl phosphite.

The second (interleaf) film as shown in FIGS. 1 and 2 is the third layer used to protect the thermoplastic polyurethane (TPU) surface which will be subsequently coated with a layer of adhesive. In certain embodiments, the second (interleaf) layer will be removed and the adhesive coating process conducted. The second (interleaf) film can be added in the flat die extrusion nip as shown in FIG. 1. The extrusion nip is formed by a rubber roller with 90 A or less hardness according to ASTM D2240 in the rear position and a polished chrome-coated or TEFLON-coated steel roller in the front position relative to the web moving direction in the flat die extrusion rig.

In various non-limiting embodiments of the invention, the second (interleaf) film may be added downstream after the flat die extrusion rig as shown in FIG. 2. After the two-layer extruded thermoplastic polyurethane (TPU) film is cooled in the extrusion rig, the web of the two-layer thermoplastic polyurethane (TPU) film enters into another pair of nip rolls, comprising at least one rubber roll of 90 A or less hardness according to ASTM D2240. The second (interleaf) film is fed into the nip and laminated onto the exposed thermoplastic polyurethane (TPU) side under pressure (5-100 psi) with the smooth or glossy surface of the interleaf film.

In certain embodiments, the interleaf film has a smooth or glossy surface on at least one side that will be laminated with the thermoplastic polyurethane (TPU) surface and can be peeled from the thermoplastic polyurethane (TPU) layer similar to or easier than the substrate film layer.

In various non-limiting embodiments of the present invention, the second (interleaf) film has a melt or softening temperature of 80° C. or greater and Young's modulus according to ASTM D882 of 50 MPa or greater. The carrier has one glossy or polished surface, the surface roughness (Ra) according to ISO 4287/88 of less than 1.0 μm and gloss (according to ISO 2813, Angle 60°) of 80% or greater. The other side of the second (interleaf) film may be of any surface finish: matte, glossy, smooth, embossed or polished, although the surface roughness (Ra) according to ISO 4287/88 of this surface is less than 10 μm, and in certain embodiments, less than 5 μm. The second (interleaf) film is an essentially planar, self-supporting, stretchable, flexible, thermoplastic polymeric film which can be transparent, translucent or opaque. It has a substantially uniform thickness, in the range from 0.025 to 0.25 mm (1 to 10 mils). Suitable second (interleaf) films may be made of polyethylene (PE), polypropylene (PP), polyethylene terephthalate (PET), polycarbonate (PC), polybutylene terephthalate (PBT), polyethylene naphthalate, glycol-polyethylene terephthalate, amorphous polyethylene terephthalate, polyvinyl chloride, cellulose triacetate, polyamide, styrene-methyl methacrylate copolymer, or cyclic olefin copolymer, or a combination thereof.

In various non-limiting embodiments, the second (interleaf) film is a 1.0 mil to 2.0 mil polyethylene terephthalate (PET) film; in certain embodiments, it is a 1.0 mil to 2.5 mil polypropylene film; and in yet other embodiments, it is a 1.0 mil to 3.0 mil polyethylene (PE) film having a glossy or polished surface finish on at least one side.

The inventive composite film thus formed with the freshly extruded, soft and sticky thermoplastic polyurethane (TPU) sandwiched by the first (substrate) and second (interleaf) films, may be easily wound into rolls of desired length by center or gap winding mechanisms. No web wrinkling issues should be encountered during the roll winding process due to separation of the sticky aliphatic thermoplastic polyurethane (TPU) from contacting the first (substrate) film of the previous wrap of the three-layer thermoplastic polyurethane (TPU) composite film during the roll winding. In the three-layer paint protection film of this invention, as the surfaces of aliphatic thermoplastic polyurethane (TPU) are in contact with glossy or smooth surfaces of the first (substrate) and second (interleaf) films, the thermoplastic polyurethane (TPU) film will maintain optical level surface qualities, free of any defects such as water mark patterns due to entrapment of air pockets between film layers during winding, contaminations or minor physical impressions resulting from the manufacturing process, storage or in subsequent procedures of adding adhesive or top coating layers.

In certain embodiments, the second (interleaf) film may be peeled off to permit the addition of a pressure sensitive adhesive that will meet requirements of different surface protection situations. A release liner may then be laminated onto the adhesive surface. In such embodiments, the surface protection film thus made will comprise the following four layers: a substrate layer, an aliphatic thermoplastic polyurethane (TPU) layer, a pressure sensitive adhesive layer and a release liner layer. Suitable pressure-sensitive adhesives are available from various commercial suppliers and may be rubber-based (butyl rubber, natural rubber, silicone rubber), polyurethane, acrylic, modified acrylic and silicone formulations.

In various non-limiting embodiments, the first (substrate) film layer may be removed and a scratch-resistant top coating applied. In these embodiments, the scratch-resistant surface protection film thus made will comprise the following: a top coating, an aliphatic thermoplastic polyurethane (TPU) layer, a pressure sensitive adhesive layer and a release liner layer. Suitable scratch-resistant top coatings are available from a variety of commercial suppliers.

The three-layer aliphatic thermoplastic polyurethane (TPU) film of the present invention may find use in providing surface protection film for a variety of products in the automotive, electronics or furniture markets.

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant(s) reserve the right to amend the claims during prosecution to add features as variously described in this specification, and such amendments comply with the requirements of 35 U.S.C. §112(a), and 35 U.S.C. §132(a).

Various aspects of the subject matter described herein are set out in the following numbered clauses:

1. A method of making a three-layer thermoplastic polyurethane (TPU) surface protection composite comprising: extruding an aliphatic thermoplastic polyurethane (TPU) melt through a flat die extrusion device to produce an aliphatic thermoplastic polyurethane (TPU) film; sandwiching the aliphatic thermoplastic polyurethane (TPU) film between a first (substrate) film and a second (interleaf) film at an extrusion nip formed by a rubber roller with 90 A or less hardness according to ASTM D2240 and a polished steel roller in the flat die extrusion device to produce the three-layer thermoplastic polyurethane (TPU) surface protection composite, wherein the first (substrate) film and a second (interleaf) film each independently have a smooth or a polished surface; cooling the three-layer thermoplastic polyurethane (TPU) surface protection composite film; and winding the three-layer thermoplastic polyurethane (TPU) surface protection composite onto a roll.

2. A method of making a three-layer thermoplastic polyurethane (TPU) surface protection composite comprising: extruding an aliphatic thermoplastic polyurethane (TPU) layer onto a smooth surface of a substrate film at a flat die extrusion nip formed by a rubber roller with 90 A or less hardness in a back position and a polished steel roll in a front position to produce a two-layer thermoplastic polyurethane (TPU) composite film; cooling the two-layer thermoplastic polyurethane (TPU) composite film; feeding the two-layer thermoplastic polyurethane (TPU) composite film into a second pair of nip rollers downstream to the flat die extrusion rig, wherein the second pair of nip rollers comprise at least one rubber roll of 90 A or less hardness according to ASTM D2240; and feeding a flexible polymer interleaf film into the second pair of nip rolls and laminating the flexible polymer interleaf film onto the exposed thermoplastic polyurethane (TPU) side of the two-layer thermoplastic polyurethane (TPU) composite film under pressure.

3. The method according to one of clauses 1 and 2, wherein the aliphatic thermoplastic polyurethane (TPU) film has a thickness of from 2 mil to 15 mil, and a hardness of from 70 Shore A to 70 Shore D according to ASTM D2240.

4. The method according to any one of clauses 1 to 3, wherein the first (substrate) film has a gauge of 1 to 10 mil.

5. The method according to any one of clauses 1 to 4, wherein the first (substrate) film has a melt or softening temperature of at least 100° C. and Young's modulus according to ASTM D882 of at least 50 MPa.

6. The method according to any one of clauses 1 to 5, wherein the first (substrate) film has at least one smooth or polished surface.

7. The method according to any one of clauses 1 to 6, wherein the first (substrate) film has a first surface with a surface roughness (Ra) according to ISO 4287/88 of less than 1.0 μm and a gloss (according to ISO 2813, Angle 60°) of at least 80%.

8. The method according to any one of clauses 1 to 7, wherein the first (substrate) film has a second surface with a surface roughness (Ra) according to ISO 4287/88 of less than 10 μm.

9. The method according to any one of clauses 1 to 8, wherein the first (substrate) film has a second surface having a surface finish selected from the group consisting of matte, glossy, smooth, embossed and polished.

10. The method according to any one of clauses 1 to 9, wherein the first (substrate) film is selected from the group consisting of polyethylene terephthalate (PET), polycarbonate (PC), polypropylene (PP), biaxially oriented polypropylene (BOPP), polyethylene (PE), polybutylene terephthalate (PBT), polyethylene naphthalate, glycol-polyethylene terephathalate (PETG), amorphous polyethylene terephthalate, polyvinyl chloride, cellulose triacetate, polyamide, styrene-methyl methacrylate copolymer, cyclic olefin copolymer, and a combination thereof.

11. The method according to any one of clauses 1 to 10, wherein the second (interleaf) film comprises one selected from the group consisting of polyethylene terephthalate (PET), polycarbonate (PC), polypropylene (PP), biaxially oriented polypropylene (BOPP), polyethylene (PE), polybutylene terephthalate (PBT), polyethylene naphthalate, glycol-polyethylene terephathalate (PETG), amorphous polyethylene terephthalate, polyvinyl chloride, cellulose triacetate, polyamide, styrene-methyl methacrylate copolymer, cyclic olefin copolymer.

12. The method according to any one of clauses 1 to 11 further including the steps of: removing the second (interleaf) film; applying a pressure sensitive adhesive layer and laminating a release liner layer.

13. The method according to any one of clauses 1 to 12 further including the steps of: removing the first (substrate) film; and applying a scratch-resistant top coating.

14. The surface protection composite made according to the method of any one of clauses 1 to 13.

1. A method of making a three-layer thermoplastic polyurethane (TPU) surface protection composite comprising:
extruding an aliphatic thermoplastic polyurethane (TPU) melt through a flat die extrusion device to produce an aliphatic thermoplastic polyurethane (TPU) film;
sandwiching the aliphatic thermoplastic polyurethane (TPU) film between a first (substrate) film and a second (interleaf) film at an extrusion nip formed by a rubber roller and a polished steel roller in the flat die extrusion device to produce the three-layer thermoplastic polyurethane (TPU) surface protection composite, wherein the first (substrate) film and a second (interleaf) film each independently have a smooth or a polished surface;
cooling the three-layer thermoplastic polyurethane (TPU) surface protection composite film; and
winding the three-layer thermoplastic polyurethane (TPU) surface protection composite onto a roll.

2. The method according to claim 1, wherein the aliphatic thermoplastic polyurethane (TPU) film has a thickness of from 2 mil to 15 mil, and a hardness of from 70 Shore A to 70 Shore D according to ASTM D2240.

3. The method according to claim 1, wherein the first (substrate) film has a gauge of 1 to 10 mil.

4. The method according to claim 1, wherein the first (substrate) film has a melt or softening temperature of at least 100° C. and Young's modulus according to ASTM D882 of at least 50 MPa.

5. The method according to claim 1, wherein the first (substrate) film has at least one smooth or polished surface.

6. The method according to claim 1, wherein the first (substrate) film has a first surface with a surface roughness (Ra) according to ISO 4287/88 of less than 1.0 μm and a gloss (according to ISO 2813, Angle 60°) of at least 80%.

7. A method of making a three-layer thermoplastic polyurethane (TPU) surface protection composite comprising:
extruding an aliphatic thermoplastic polyurethane (TPU) melt through a flat die extrusion device to produce an aliphatic thermoplastic polyurethane (TPU) film;
sandwiching the aliphatic thermoplastic polyurethane (TPU) film between a first (substrate) film and a second (interleaf) film at an extrusion nip formed by a rubber roller with 90 A or less hardness according to ASTM D2240 and a polished steel roller in the flat die extrusion device to produce the three-layer thermoplastic polyurethane (TPU) surface protection composite, wherein the first (substrate) film and a second (interleaf) film each independently have a smooth or a polished surface;
cooling the three-layer thermoplastic polyurethane (TPU) surface protection composite film;
winding the three-layer thermoplastic polyurethane (TPU) surface protection composite onto a roll;
removing the second (interleaf) film;
applying a pressure sensitive adhesive layer;
laminating a release liner layer,
removing the first (substrate) film;
and
applying a scratch-resistant top coating.

8. The method according to claim 1, wherein the first (substrate) film has a second surface with a surface roughness (Ra) according to ISO 4287/88 of less than 10 μm.

9. The method according to claim 1, wherein the first (substrate) film has a second surface having a surface finish selected from the group consisting of matte, glossy, smooth, embossed and polished.

10. The method according to claim 1, wherein the first (substrate) film is selected from the group consisting of polyethylene terephthalate (PET), polycarbonate (PC), polypropylene (PP), biaxially oriented polypropylene (BOPP), polyethylene (PE), polybutylene terephthalate (PBT), polyethylene naphthalate, glycol-polyethylene terephathalate (PETG), amorphous polyethylene terephthalate, polyvinyl chloride, cellulose triacetate, polyamide, styrene-methyl methacrylate copolymer, cyclic olefin copolymer, and a combination thereof.

11. The method according to claim 1, wherein the second (interleaf) film comprises one selected from the group consisting of polyethylene terephthalate (PET), polycarbonate (PC), polypropylene (PP), biaxially oriented polypropylene (BOPP), polyethylene (PE), polybutylene terephthalate (PBT), polyethylene naphthalate, glycol-polyethylene terephathalate (PETG), amorphous polyethylene terephthalate, polyvinyl chloride, cellulose triacetate, polyamide, styrene-methyl methacrylate copolymer, and cyclic olefin copolymer.

12. A method of making a three-layer thermoplastic polyurethane (TPU) surface protection composite comprising:
extruding an aliphatic thermoplastic polyurethane (TPU) melt through a flat die extrusion device to produce an aliphatic thermoplastic polyurethane (TPU) film;
sandwiching the aliphatic thermoplastic polyurethane (TPU) film between a first (substrate) film and a second (interleaf) film at an extrusion nip formed by a rubber roller with 90 A or less hardness according to ASTM D2240 and a polished steel roller in the flat die extrusion device to produce the three-layer thermoplastic polyurethane (TPU) surface protection composite, wherein the first (substrate) film and a second (interleaf) film each independently have a smooth or a polished surface;
cooling the three-layer thermoplastic polyurethane (TPU) surface protection composite film; and
winding the three-layer thermoplastic polyurethane (TPU) surface protection composite onto a roll;
removing the second (interleaf) film;
applying a pressure sensitive adhesive layer;
and
laminating a release liner layer.

13. A method of making a three-layer thermoplastic polyurethane (TPU) surface protection composite comprising:
extruding an aliphatic thermoplastic polyurethane (TPU) melt through a flat die extrusion device to produce an aliphatic thermoplastic polyurethane (TPU) film;
sandwiching the aliphatic thermoplastic polyurethane (TPU) film between a first (substrate) film and a second (interleaf) film at an extrusion nip formed by a rubber roller with 90 A or less hardness according to ASTM D2240 and a polished steel roller in the flat die extrusion device to produce the three-layer thermoplastic polyurethane (TPU) surface protection composite, wherein the first (substrate) film and a second (interleaf) film each independently have a smooth or a polished surface;
cooling the three-layer thermoplastic polyurethane (TPU) surface protection composite film; and
winding the three-layer thermoplastic polyurethane (TPU) surface protection composite onto a roll;
removing the first (substrate) film;
and
applying a scratch-resistant top coating.

14. A surface protection composite made according to the method of claim 1.

15. The method according to claim 1, wherein the three-layer thermoplastic polyurethane (TPU) surface protection composite is free of water mark patterns resulting from entrapment of air pockets between film layers during winding.
